(19) United States
(12) Patent Application Publication
(10) Pub. No.: US 2009/0260176 A1
(43) Pub. Date: Oct. 22, 2009

(54) WINDSHIELD WIPER DEVICE

(75) Inventor: Achim Hawighorst, Buehlertal (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/305,256

(22) PCT Filed: Dec. 3, 2007
(86) PCT No.: PCT/EP2007/063134

§ 371 Date: Dec. 17, 2008

(30) Foreign Application Priority Data
Dec. 28, 2006 (DE) 10 2006 061 675.8

(51) Int. Cl. B60S 1/04

(52) U.S. Cl. 15/250.001

(57) ABSTRACT

The invention relates to a window wiper device (10), in particular for a motor vehicle, having a tubular plate (11) and a wiper motor (14). Until now the wiper motor (14) has been connected to the tubular plate (11) in a relatively costly fashion by means of a mounting plate. For this reason, according to the invention the tubular plate (11) can be attached directly to the wiper motor (14).

### BACKGROUND AND SUMMARY OF THE INVENTION

The invention relates to a windshield wiper device, in particular for a motor vehicle, comprising a tubular plate and a wiper motor.

Generally windshield wiper devices are connected to a vehicle body at at least three points. For connecting the wiper motor to the tubular plate, hitherto a mounting plate has been used, which in turn is connected to the vehicle body. The mounting plate represents an additional manufacturing and mounting cost.

The object of the invention, therefore, is to improve a windshield wiper device of the aforementioned type, such that a mounting plate is able to be dispensed with in the future.

The invention solves the above problem by a windshield wiper device of the aforementioned type, in which according to the invention the tubular plate may be fastened directly to the wiper motor. Thus the hitherto used mounting plate may be dispensed with in the future, whereby the manufacturing and mounting cost is reduced.

The tubular plate may comprise at one of its two end regions a fastening element for connecting to a vehicle body. To this end, the tubular plate may be lengthened beyond the region in which the mounting plate was hitherto arranged. The mounting plate is thus also no longer required for connecting to the vehicle body.

For the purpose of improved mountability, the tubular plate in its end region at which it may be connected to the vehicle body, may have a transition region to a region of lower thickness. In this manner, more freedom of movement is provided to the installation personnel which is required for fastening the tubular plate to the body.

During the mounting process, screw connections are generally relatively time-consuming. Therefore, the tubular plate may have a plug-like fastening element in its end region, by means of which the tubular plate may be fastened rapidly to the vehicle body with a single movement.

Advantageously, the plug-like fastening element is made from a resilient material, preferably an elastomer, which may be pressed into an opening in the vehicle body, the plug-like fastening element being compressed. As a result of the resilient material, the fastening element also simultaneously undertakes the function of a decoupling element, whereby acoustic vibrations are prevented from being transmitted from the windshield wiper device to the vehicle body. If the plug-like fastening element is additionally further provided with an undercut, it is positively connected to the vehicle body, whereby a secure fastening of the tubular plate to the vehicle body is ensured.

The tubular plate in its end region may have a jaw-like recess, which may be pushed over a decoupling element located on the vehicle body. As a result of the jaw-like recess, the tubular plate may also be fastened to the vehicle body in a single movement.

Also, it proves advantageous in practice to provide the tubular plate in its end region with a bore, into which a decoupling element which may be screwed to the vehicle body may be inserted.

So that the mounting plate may also be dispensed with when connecting the wiper motor to the vehicle body, the wiper motor may be provided with a fastening element for connecting to the vehicle body.

So that the windshield wiper device is connected to the vehicle body at at least three points, an articulated part may also comprise a fastening element for connecting to the vehicle body.

### BRIEF DESCRIPTION OF THE DRAWINGS

Various embodiments of the windshield wiper device according to the invention are described in more detail with reference to the accompanying drawings, in which in detail:

FIG. 1 shows a plan view of a first embodiment of a windshield wiper device;

FIG. 2 shows a plan view of a second embodiment of the windshield wiper device;

FIG. 3 shows a side view of the windshield wiper device of FIG. 2;

FIG. 4 shows a plan view of the end region of a tubular plate;

FIG. 5 shows a side view of the end region of the tubular plate of FIG. 4.

### DETAILED DESCRIPTION

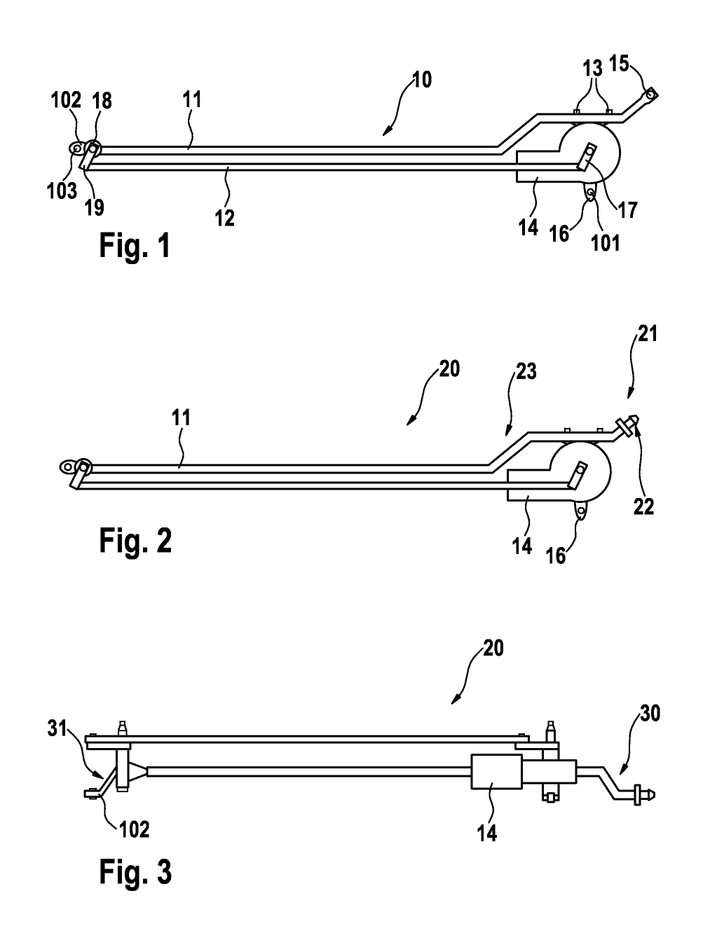

FIG. 1 shows a windshield wiper device 10 comprising a tubular plate 11 and a wiper rod assembly 12.

The wiper rod assembly 12 connects a motor crank 17 of a wiper motor 14 to an articulated crank 19 arranged on an articulated part 18.

The tubular plate 11 is directly fastened to the wiper motor 14 by means of screws 13. A mounting plate hitherto used is thus no longer required.

The tubular plate 11 is in its end region screwed to a vehicle body, not shown here in more detail, by a screw-shaped fastening element 15. The mounting plate may thus also be dispensed with for connecting the tubular plate 11 to the vehicle body.

So that the mounting plate may also be dispensed with for the connection between the wiper motor 14 and the vehicle body, not shown, the wiper motor 14 is able to be connected by a fastening element 16 to the vehicle body, the fastening element 16 being screwed to the vehicle body by means of a screw 101.

The articulated part 18 is connected by a fastening element 102 to the vehicle body. The fastening element 102 is screwed by a screw 103 to the vehicle body.

FIG. 2 shows a windshield wiper device 20, the tubular plate 11 thereof being fastened by a plug-like fastening element 21 to the vehicle body. The plug-like fastening element 21 is made from a resilient material, so that it is compressed when it is pressed into an opening of the vehicle body, not shown here in more detail. By means of the resilient material, the fastening element 21 also simultaneously undertakes the function of a decoupling element which prevents acoustic vibrations from being transmitted from the windshield wiper device 20 to the vehicle body.

The fastening element 21 has an undercut 22. Thus it may be positively connected to the vehicle body, in order to ensure a secure fastening of the tubular plate 11 to the vehicle body.

The tubular plate 11 has an angled region 23 in the region of the wiper motor 14, in order to guide the tubular plate 11 past the wiper motor 14.

As FIG. 3 shows, the tubular plate 20 has an angled region 30 and the articulated part 102 has an angled region 31, in order to ensure a spacing between the vehicle body and the wiper motor 14.

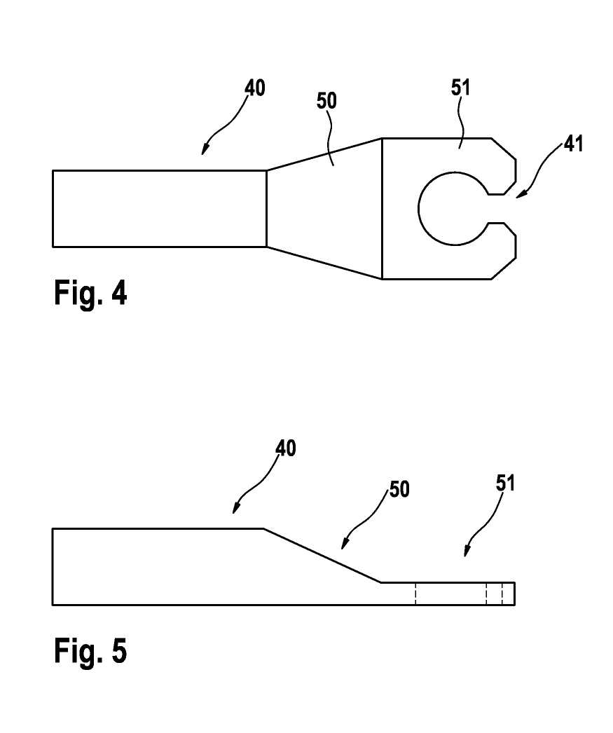

FIGS. 4 and 5 show a tubular plate 40 which at its end region has a jaw-like recess 41. The jaw-like recess 41 may be pushed in a single movement over a decoupling element inserted into the vehicle body, not shown here in more detail.

The tubular plate 40 has at its end region a transition region 50 which leads to a region 51 of lower thickness. By means of the transition region 50 and the region 51, installation personnel are allowed sufficient freedom of movement which is required for fastening the tubular plate 40 to the vehicle body.

1. A windshield wiper device (10, 20), comprising a tubular plate (11, 40) and a wiper motor (14), characterized in that the tubular plate (11, 40) is directly fastened to the wiper motor (14).

2. The windshield wiper device (10, 20) as claimed in claim 1, characterized in that the tubular plate (11, 40) comprises at one of its two end regions a fastening element (15, 21) for connecting to a vehicle body.

3. The windshield wiper device as claimed in claim 1, characterized in that the tubular plate (40) in its end region at which it may be connected to a vehicle body, has a transition region (50) to a region (51) of lower thickness.

4. The windshield wiper device (10, 20) as claimed in claim 1, characterized in that the tubular plate (11) in its end region has a plug-like fastening element (21).

5. The windshield wiper device (10, 20) as claimed in claim 4, characterized in that the plug-like fastening element (21) is made from a resilient material and has an undercut (22).

6. The windshield wiper device as claimed in claim 1, characterized in that the tubular plate (40) in its end region has a jaw-like recess (41), which may be pushed over a decoupling element located on a vehicle body.

7. The windshield wiper device (10, 20) as claimed in claim 1, characterized in that the tubular plate (11) in its end region has a bore, into which a decoupling element which may be screwed to a vehicle body may be inserted.

8. The windshield wiper device (10, 20), as claimed in claim 1, characterized in that the wiper motor (14) also comprises a fastening element (16) for connecting to a vehicle body.

9. The windshield wiper device (10, 20), as claimed in claim 1, characterized in that an articulated part (18) also comprises a fastening element (102) for connecting to a vehicle body.

10. The windshield wiper device as claimed in claim 2, characterized in that the tubular plate (40) in its end region at which it may be connected to the vehicle body, has a transition region (50) to a region (51) of lower thickness.

11. The windshield wiper device (10, 20) as claimed in claim 10, characterized in that the tubular plate (11) in its end region has a plug-like fastening element (21).

12. The windshield wiper device (10, 20) as claimed in claim 11, characterized in that the plug-like fastening element (21) is made from a resilient material and has an undercut (22).

13. The windshield wiper device as claimed in claim 12, characterized in that the tubular plate (40) in its end region has a jaw-like recess (41), which may be pushed over a decoupling element located on the vehicle body.

14. The windshield wiper device (10, 20) as claimed in claim 13, characterized in that the tubular plate (11) in its end region has a bore, into which a decoupling element which may be screwed to the vehicle body may be inserted.

15. The windshield wiper device (10, 20), as claimed in claim 14, characterized in that the wiper motor (14) also comprises a fastening element (16) for connecting to the vehicle body.

16. The windshield wiper device (10, 20), as claimed in claim 15, characterized in that an articulated part (18) also comprises a fastening element (102) for connecting to the vehicle body.
